(19) United States
(12) Patent Application Publication
(10) Pub. No.: US 2012/0320733 A1
(43) Pub. Date: Dec. 20, 2012

(54) REDUCING EVOLVED PACKET CORE INTERNET PROTOCOL SERVICE DISCONNECTS DURING INTER-RADIO ACCESS TECHNOLOGY HANDOVER

(75) Inventors: Suli Zhao, San Diego, CA (US); Ajith Tom Payyappilly, San Diego, CA (US); Jinghui Yang, San Diego, CA (US); Sidharth D. Chitnis, San Diego, CA (US); Shrawan Kumar Khatri, San Diego, CA (US)

(73) Assignee: QUALCOMM Incorporated, San Diego, CA (US)

(21) Appl. No.: 13/460,788

(22) Filed: Apr. 30, 2012

Related U.S. Application Data
(60) Provisional application No. 61/496,993, filed on Jun. 14, 2011.

(51) Int. Cl. H04W 24/00; H04W 36/00

(52) U.S. Cl. 370/216

(57) ABSTRACT

During inter-radio access technology (IRAT) handover between LTE and eHRPD technologies, Internet protocol (IP) service continuity at a user equipment (UE) may be maintained. Thus, a method, an apparatus, and a computer program product are provided for maintaining the IP service continuity during IRAT handover from an SRAT to a TRAT within an evolved packet core (EPC)—capable region. The apparatus attempts to transfer an EPC context to a TRAT, determines that a failure occurs when attempting to transfer the EPC context to the TRAT, and attempts to maintain at least one IP service continuity within the EPC context according to the failure. The attempt to maintain may include an attempt to maintain an entire EPC context or a set of parameters including at least one of an IP address, a domain name system (DNS) address, a proxy call session control function (P-CSCF) address, or a quality of service (QoS).

### CROSS-REFERENCE TO RELATED APPLICATION(S)

This application claims the benefit of U.S. Provisional Application Ser. No. 61/496,993, entitled “METHOD AND APPARATUS FOR EPC CONTEXT MAINTENANCE OPTIMIZATION” and filed on Jun. 14, 2011, which is expressly incorporated by reference herein in its entirety.

### BACKGROUND

1. Field

The present disclosure relates generally to communication systems, and more particularly, to reducing evolved packet core (EPC) Internet Protocol (IP) service disconnects during inter-radio access technology (IRAT) handover between LTE and eHRPD technologies.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

During inter-radio access technology (IRAT) handover between LTE and eHRPD technologies, Internet protocol (IP) service continuity at a user equipment (UE) may be maintained. In an aspect of the disclosure, a method, an apparatus, and a computer program product are provided, wherein when the UE moves from a source radio access technology (SRAT) to a target radio access technology (TRAT) within a common core network region (e.g., evolved packet core (EPC)-capable region), the UE may attempt to transfer a common core network data context (e.g., EPC context) to the TRAT. However, the UE may encounter a failure when attempting the transfer. As such, the UE may attempt to maintain at least one IP service continuity within the common core network data context according to the failure. The attempt to maintain the at least one IP service continuity may include an attempt to maintain an entire common core network data context, or at least a set of parameters including at least one of an IP address, a domain name system (DNS) address, a proxy call session control function (P-CSCF) address, or a quality of service (QoS).

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating an interface between an evolved universal terrestrial radio access network (E-UTRAN)/evolved packet core (EPC) system and a 3GPP2 core network.

FIG. 8 is a diagram illustrating inter-radio access technology (IRAT) handover.

FIGS. 9A and 9B are diagrams illustrating a method for maintaining Internet protocol (IP) service continuity during (IRAT) handover from a source radio access technology (SRAT) to a target radio access technology (TRAT) within a common core network region.

FIG. 10 is a conceptual data flow diagram illustrating the data flow between different modules/means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

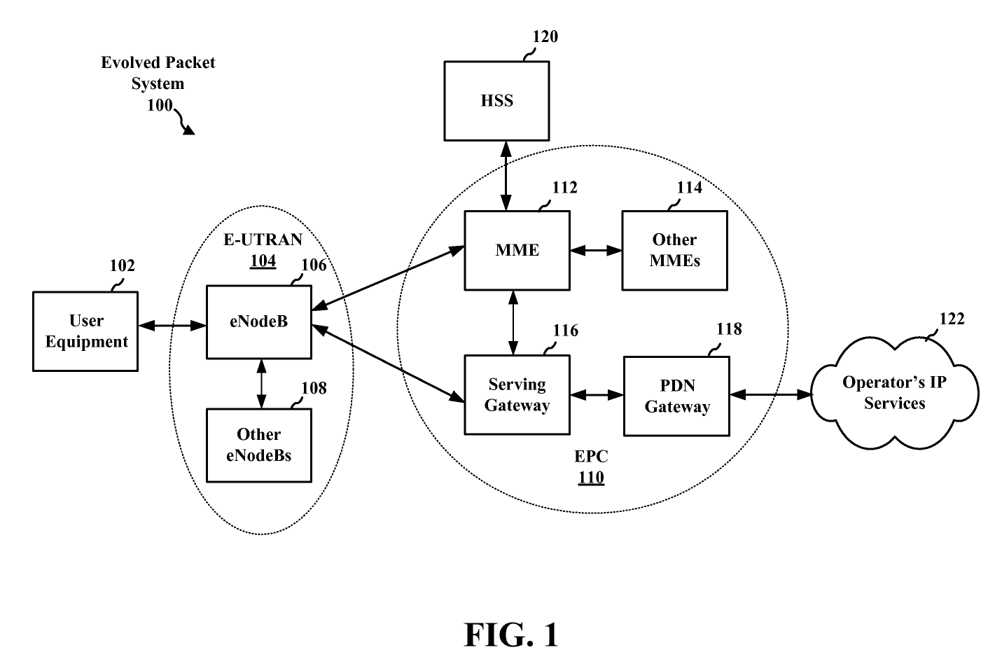

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

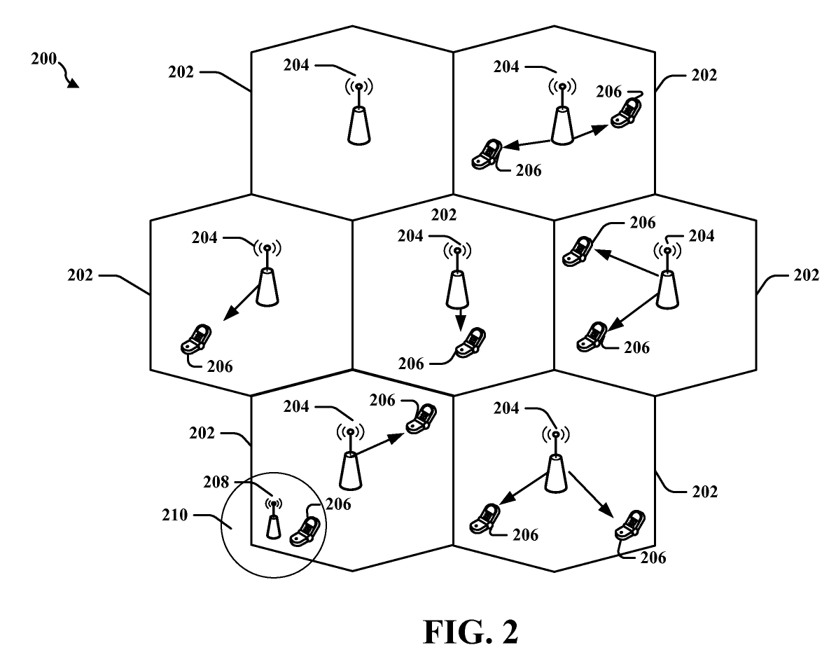

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

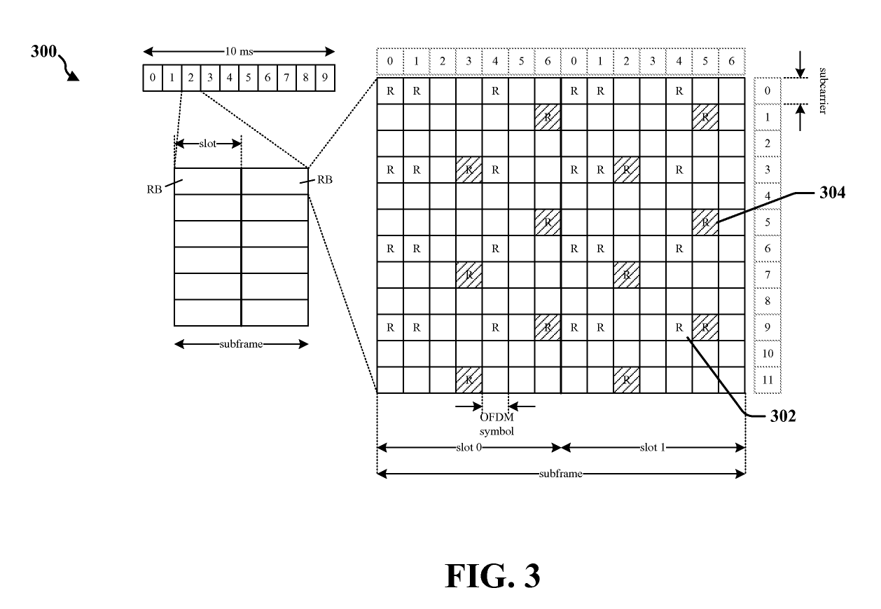

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

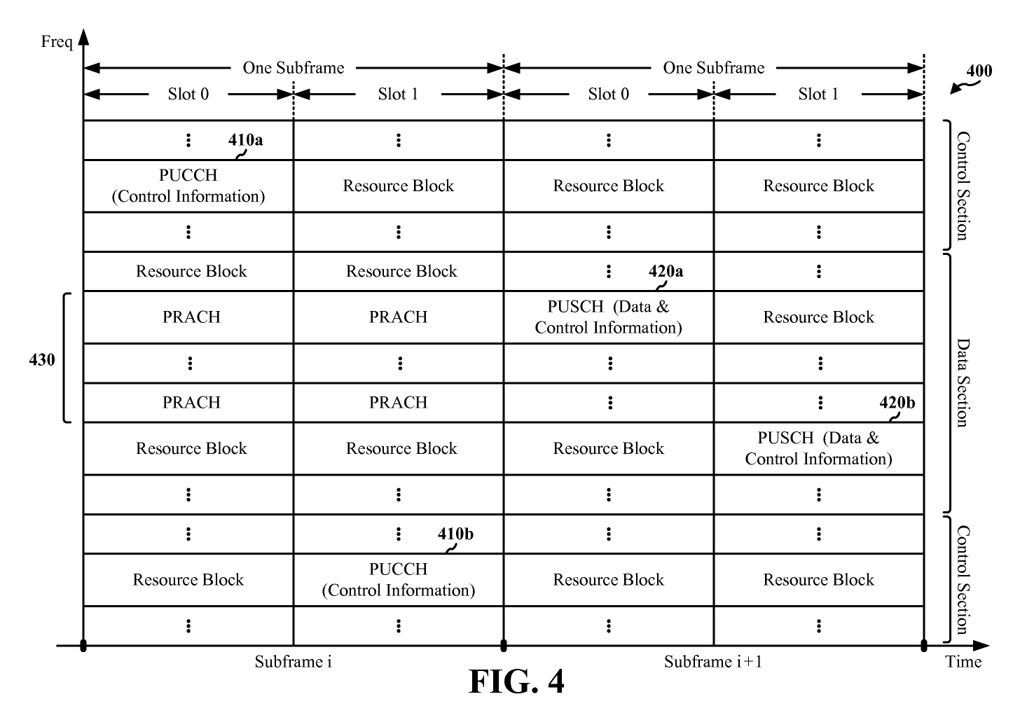

FIG. 4 is a diagram 400 illustrating an example of an UL frame structure in

LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

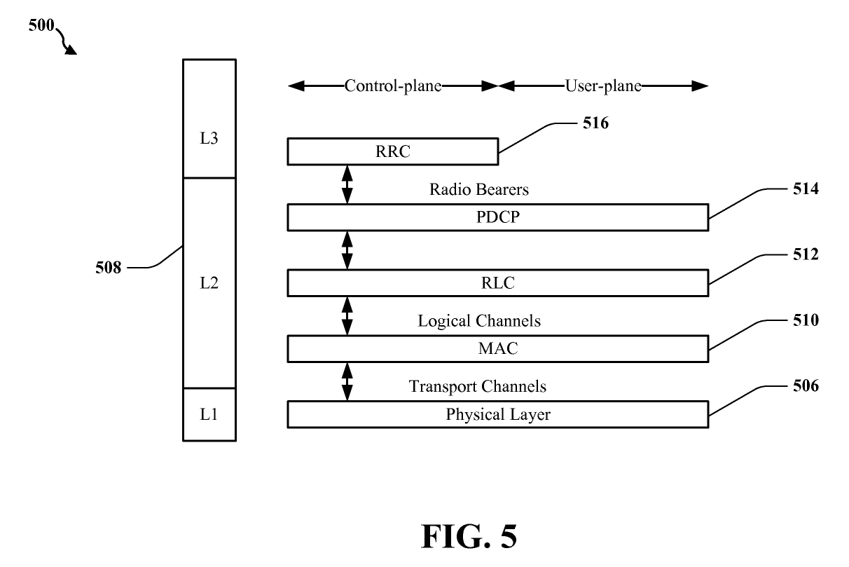

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

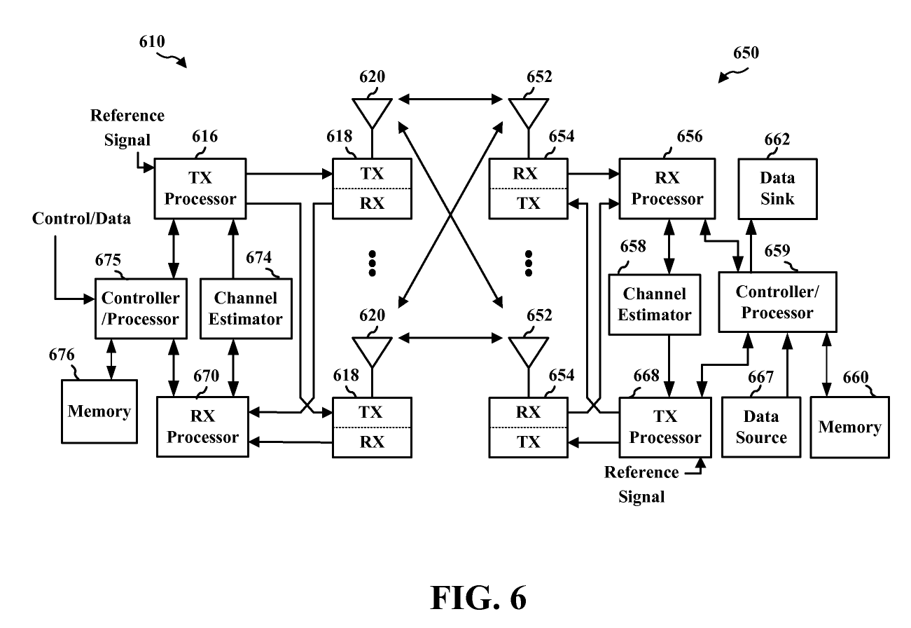

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

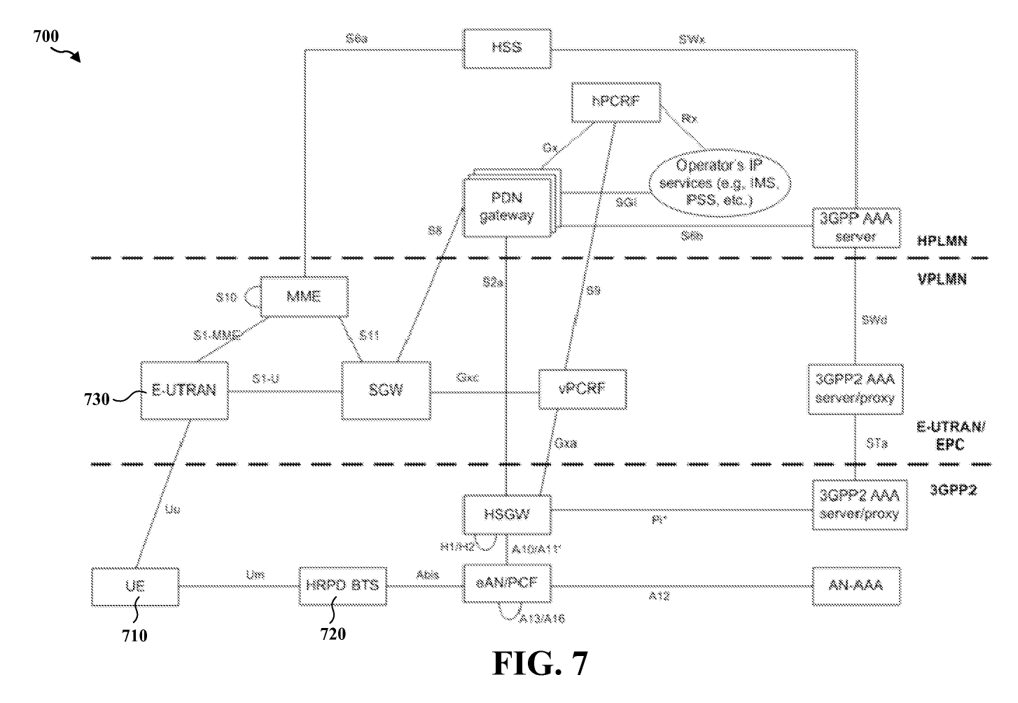

FIG. 7 is a diagram 700 illustrating an interface between an evolved universal terrestrial radio access network (E-UTRAN)/evolved packet core (EPC) system and a 3GPP2 core network. In one example, the UE 710 may have radio access to a high rate packet data (HRPD) base transceiver station (BTS) 720 and E-UTRAN 730. As such, FIG. 7 illustrates how the UE 710 accesses the EPC from an LTE radio access technology and an enhanced high rate packet data (eHRPD) radio access technology.

The EPC is a common core network for an LTE or eHRPD wireless communication system. The core network serves as a common backbone infrastructure for a wireless communication system. The EPC may include any one of the following entities: mobility management entity (MME), serving gateway (SGW), packet data network (PDN) gateway, home subscriber service (HSS), access network discovery and selection function (ANDSF), evolved packet data gateway (ePDG), etc.

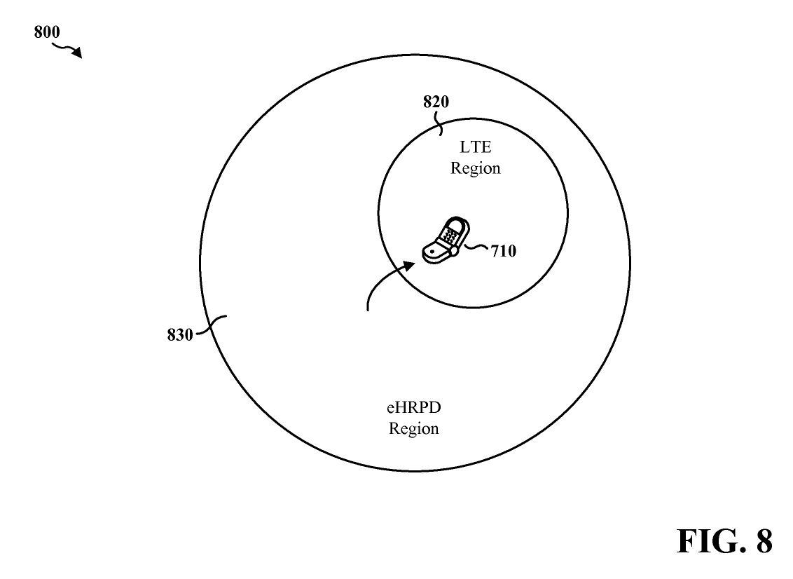

FIG. 8 is a diagram 800 illustrating inter-radio access technology (IRAT) handover. During IRAT handover between LTE and eHRPD, Internet protocol (IP) service continuity at the UE 710 may be maintained.

Referring to FIGS. 7 and 8, an IRAT handover scenario includes the UE 710 moving from a region 830 where eHRPD is deployed to a region 820 where LTE is deployed, for example. In this example, a serving data system changes from eHRPD to LTE. Alternatively, the IRAT handover scenario may include the UE 710 moving from the LTE region 820 to the eHRPD region 830. In this alternative, the serving data system changes from LTE to eHRPD.

During the IRAT handover, the UE 710 may maintain one or more IP service continuities within a common core network data context (e.g., EPC context). The UE 710 may do so by attempting to maintain, during the IRAT handover, a set of parameters including at least one of an IP address, a domain name system (DNS) address, a proxy call session control function (P-CSCF) address, or a quality of service (QoS). The UE 710 may also attempt to maintain at least one IP service continuity by attempting to maintain an entire EPC context during the IRAT handover.

Still referring to FIGS. 7 and 8, during the IRAT handover, the UE 710 moves from a source radio access technology (SRAT) (e.g., eHRPD) to a target radio access technology (TRAT) (e.g., LTE). Thus, in order for the UE 710 to maintain IP service continuity, the UE 710 needs to establish/transfer the EPC context for/to the TRAT. If the TRAT is LTE, then the UE 710 may perform an LTE attachment (e.g., initial attachment) procedure and/or a handover attachment procedure to each packet data network (PDN) that the UE 710 was connected to in the SRAT. If the TRAT is eHRPD, then the UE may perform link control protocol (LCP) procedures and/or vendor specific network control protocol (VSNCP) procedures to attach to the eHRPD.

The initial attachment procedure may involve the UE 710 initially attaching to a radio access technology (RAT) when the UE 710 has no previous IP address assigned for an IP service. The handover attachment procedure may involve the UE 710 attaching to a RAT when the UE 710 previously has an IP address assigned for an IP service.

If a failure occurs (e.g., no EPC context transferred) during the above procedures, the UE 710 will release the EPC context and IP service is disconnected. Failures may be caused by poor radio conditions at edges of the LTE/eHRPD regions, which therefore cause failures during EPC context transfer. Failures may also be due to immaturity of network entities when a carrier initially launches new networks. Moreover, problems may occur when the UE 710 moves back to the SRAT after a failed connection to the TRAT (e.g., no EPC context transferred).

In an aspect of the disclosure, a method is provided to enhance IP service continuity during IRAT handover within a common core network region (e.g., EPC-capable region). The method allows symmetric behavior in both directions of handover between LTE and eHRPD.

Reasons for failure may be categorized into temporary failures and permanent failures. Based on a type of the failure reason, the UE 710 will act differently to maintain IP service continuity during IRAT handover. For example, when a temporary failure occurs, the UE 710 may perform multiple retries of a handover attachment procedure to help recover from the temporary failure. If performing a retry succeeds in recovering from the temporary failure, then IP service continuity is maintained.

When a permanent failure occurs, the UE 710 may try to reconnect to the PDN by performing an initial attachment procedure. If the initial attachment procedure succeeds in connecting to the PDN, the UE 710 receives an assigned IP address from the PDN. The UE 710 then returns the assigned IP address to an application running on the UE 710 and IP service continuity may be maintained. For example, after the successful initial attachment procedure is performed, if the IP address assigned by a network is the same as an IP address previously assigned to the UE, then IP service continuity is maintained. In another example, after the successful initial attachment procedure is performed, if the IP address assigned by the network is different from an IP address previously assigned to the UE, then IP service continuity is maintained if the application is able to handle the different IP address.

When the UE 710 moves back to the SRAT after a failed connection to the

TRAT (e.g., no EPC context transferred to the TRAT), the UE may retry an attachment procedure over the SRAT. Moreover, after the UE attempts to recover from a failure without success, the UE gives up the attempt and declares a failure to the application within some time. This prevents an unstable state and potential loops.

Temporary failures may be defined as failures that are recoverable during some short period of time. Examples of temporary failures include: 1) UE cannot open connection due to radio failures over eHRPD; 2) eHRPD LCP timeout; 3) eHRPD PDN level temporary failures (e.g., VSNCP timeout); 4) LTE radio layer failures; and 5) LTE PDN level temporary failures (e.g., insufficient resources, network temporary failures, etc.)

Permanent failures may be defined as failures that are non-recoverable during some short period of time. Hence, the UE cannot successfully connect to the PDN even if the UE performs retries. Examples of permanent failures include: 1) eHRPD service authentication failures; 2) Network rejection of PDN connection; and 3) LTE attachment procedure failures.

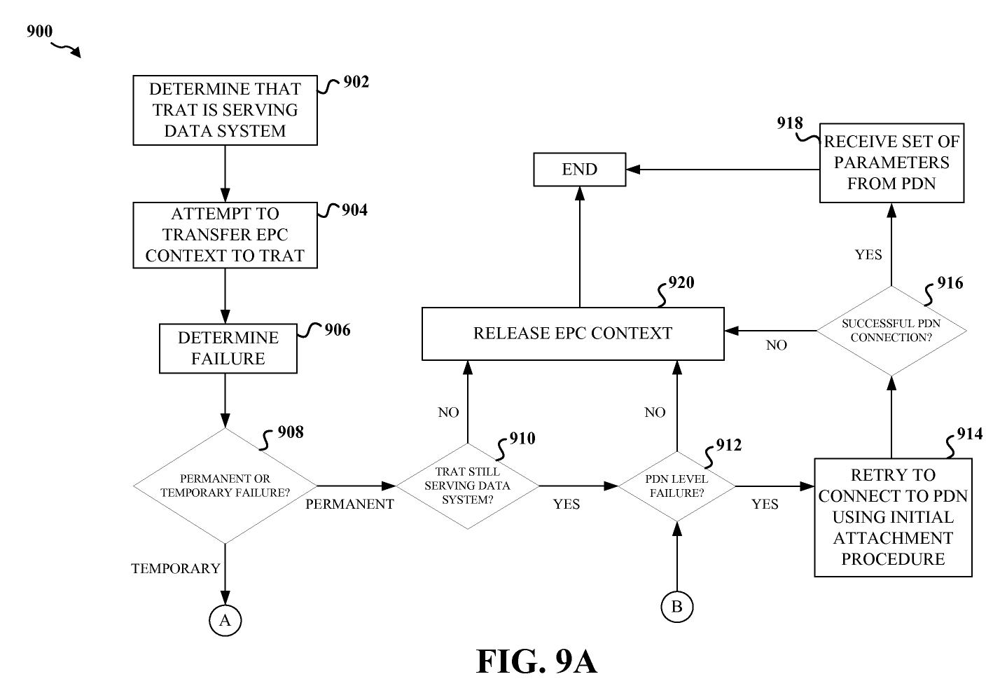

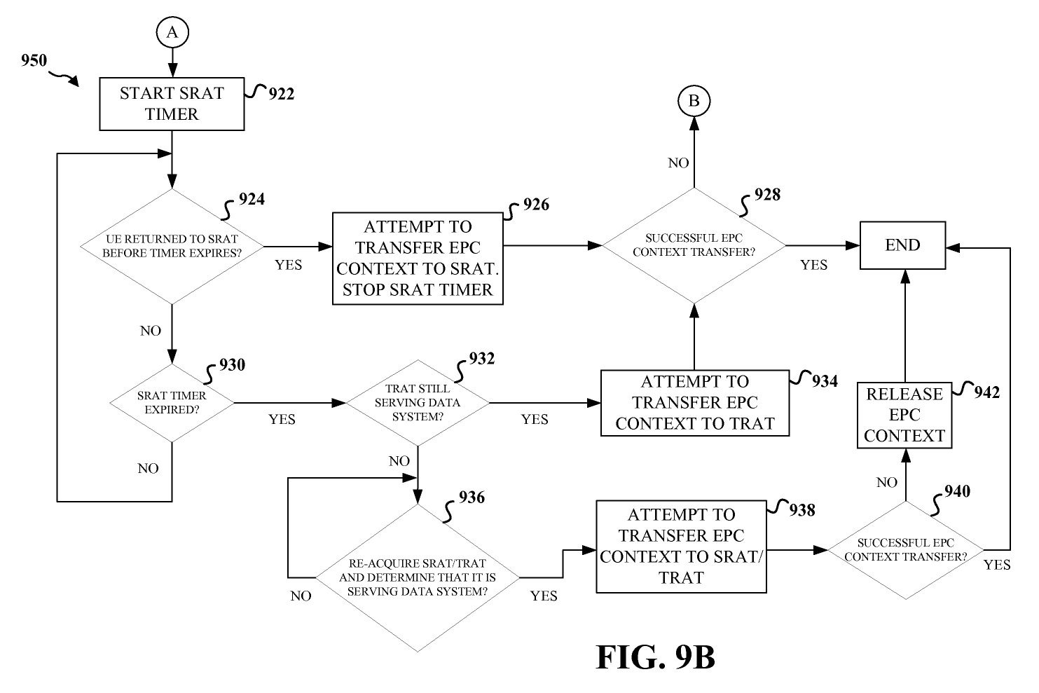

FIG. 9A is a diagram 900 illustrating a method for maintaining Internet protocol (IP) service continuity during inter-radio access technology (IRAT) handover from a source radio access technology (SRAT) to a target radio access technology (TRAT) within a common core network region. FIG. 9B is a diagram 950 further illustrating the method. The method may be performed by a UE. The SRAT may be a long term evolution (LTE) communication system and the TRAT may be an enhanced high rate packet data (eHRPD) communication system. Alternatively, the SRAT may be the eHRPD) communication system and the TRAT may be the LTE communication system.

Generally, when the UE moves from the SRAT to the TRAT, the UE may attempt to transfer a common core network data context (e.g., EPC context) to the TRAT. However, the UE may encounter a failure when attempting the transfer. As such, the UE may attempt to maintain at least one IP service continuity within the common core network data context according to the failure. The attempt to maintain the at least one IP service continuity may include an attempt to maintain an entire common core network data context, or at least a set of parameters including at least one of an IP address, a domain name system (DNS) address, a proxy call session control function (P-CSCF) address, or a quality of service (QoS).

In more detail, referring to FIGS. 9A and 9B, when the UE moves from the SRAT to the TRAT, at step 902, the UE determines that the TRAT is a serving data system. At step 904, the UE attempts to transfer the common core network data context (e.g., EPC context) to the TRAT. However, at step 906, the UE may determine that a failure occurs when attempting to transfer the common core network data context to the TRAT.

At step 908, the UE may categorize the failure as either a temporary failure or a permanent failure. Thereafter, the UE may attempt to maintain the at least one IP service continuity based on the failure categorization.

At step 910, when the UE categorizes the failure as the permanent failure, the UE further determines whether the TRAT continues to be the serving data system. At step 920, when the UE determines that the TRAT does not continue to be the serving data system, the UE releases the common core network data context.

At step 912, when the UE determines that the TRAT continues to be the serving data system, the UE determines whether a failure occurred at a packet data network (PDN) level. When the UE determines that the failure did not occur at the PDN level, the UE proceeds to step 920 and releases the common core network data context.

At step 914, when the UE determines that the failure occurred at the PDN level, the UE retries to connect to the PDN by performing an initial attachment procedure. At step 916, the UE determines whether the UE has successfully connected to the PDN. If the UE is unable to successfully connect to the PDN, the UE proceeds to step 920 and releases the common core network data context.

At step 918, when the UE successfully connects to the PDN, the UE may receive a set of parameters from the PDN, and return the set of parameters to an application running on the UE. The set of parameters may include at least one of an IP address, a domain name system (DNS) address, a proxy call session control function (P-CSCF) address, or a quality of service (QoS).

Referring back to step 908, when the UE categorizes the failure as the temporary failure, the UE proceeds to step 922 of FIG. 9B. At step 922, the UE starts an SRAT timer. Thereafter, at step 924, the UE determines whether the UE has returned to the SRAT before the SRAT timer expires.

At step 926, when the UE has returned to the SRAT before the SRAT timer expires, the UE attempts to transfer the common core network data context to the SRAT by performing a handover attachment procedure, and then stops the SRAT timer. Thereafter, at step 928, the UE determines whether the UE has successfully transferred the common core network data context to the SRAT. If the UE is able to transfer the common core network data context to the SRAT, then the UE maintains IP service continuity in the SRAT. However, if the UE determines that the transfer of the common core network data context is not successful, then the UE proceeds back to step 912 of FIG. 9A to determine whether a failure occurred at the PDN level. Thereafter, the UE proceeds to any one of steps 914, 916, 918, or 920, as described above.

Referring back to step 924, when the UE has not returned to the SRAT, at step 930, the UE determines if the SRAT timer has expired. At step 932, after the SRAT timer has expired, the UE determines whether the TRAT continues to be the serving data system.

At step 934, after the UE determines that the TRAT continues to be the serving data system, the UE attempts to transfer the common core network data context to the TRAT by performing a handover attachment procedure. At step 928, the UE determines whether the UE has successfully transferred the common core network data context to the TRAT. If the UE is able to transfer the common core network data context to the TRAT, then the UE maintains IP service continuity in the TRAT. However, if the UE determines that the transfer of the common core network data context is not successful, then the UE proceeds back to step 912 of FIG. 9A to determine whether a failure occurred at the PDN level. Thereafter, the UE proceeds to any one of steps 914, 916, 918, or 920, as described above.

Referring back to step 932, when the UE determines that the TRAT does not continue to be the serving data system at the time when the SRAT timer expires, at step 936, the UE determines whether a connection with the SRAT or TRAT has been re-acquired and the SRAT or TRAT has been determined to be the serving data system. At step 938, when the connection with the SRAT or TRAT has been re-acquired and the SRAT or TRAT has been determined to be the serving data system, the UE attempts to transfer the common core network data context to the SRAT or TRAT by performing a handover attachment procedure. At step 940, the UE determines whether the UE has successfully transferred the common core network data context to the SRAT or TRAT. If the UE is able to transfer the common core network data context to the SRAT or TRAT, then the UE maintains IP service continuity in the SRAT or TRAT. However, if the UE determines that the transfer of the common core network data context is not successful, then the UE proceeds to step 942 and releases the common core network data context.

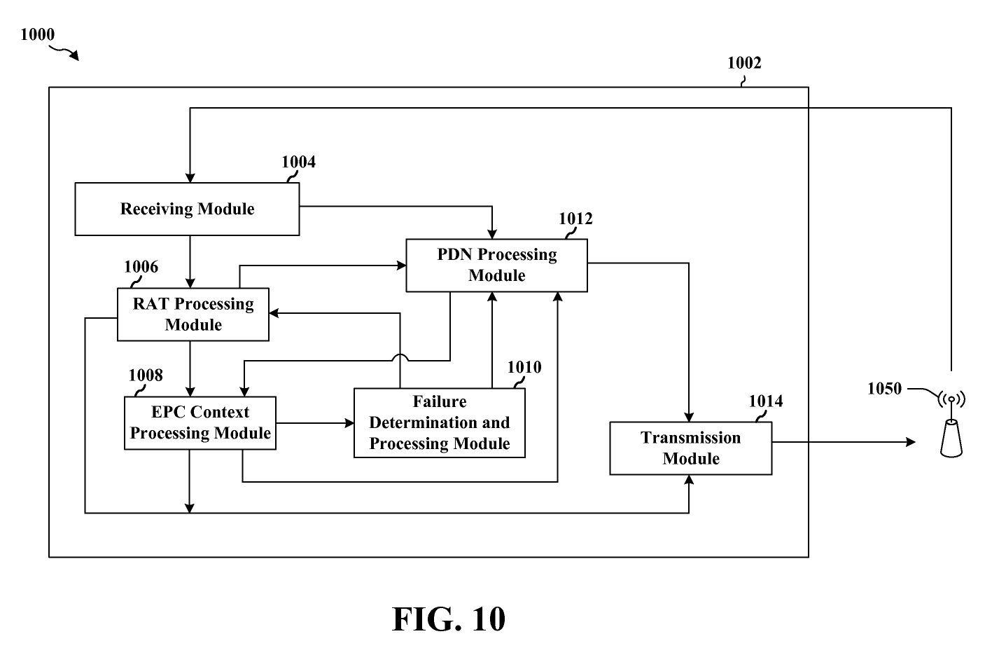

FIG. 10 is a conceptual data flow diagram 1000 illustrating the data flow between different modules/means/components in an exemplary apparatus 1002 performing a method for maintaining Internet protocol (IP) service continuity during inter-radio access technology (IRAT) handover from a source radio access technology (SRAT) to a target radio access technology (TRAT) within a common core network region. The apparatus may be a UE. The apparatus includes a receiving module 1004, a radio access technology (RAT) processing module 1006, an EPC context processing module 1008, a failure determination and processing module 1010, a packet data network (PDN) processing module 1012, and a transmission module 1014.

The SRAT may be a long term evolution (LTE) communication system and the TRAT may be an enhanced high rate packet data (eHRPD) communication system. Alternatively, the SRAT may be the eHRPD communication system and the TRAT may be the LTE communication system.

Generally, when the apparatus 1002 moves from the SRAT to the TRAT, the modules depicted in FIG. 10 facilitate the apparatus 1002 to attempt to transfer a common core network data context (e.g., EPC context) to the TRAT. When the apparatus 1002, encounters a failure when attempting the transfer, the modules of FIG. 10 facilitate the apparatus 1002 to attempt to maintain at least one IP service continuity within the common core network data context according to the failure. The attempt to maintain the at least one IP service continuity may include an attempt to maintain an entire common core network data context, or at least a set of parameters including at least one of an IP address, a domain name system (DNS) address, a proxy call session control function (P-CSCF) address, or a quality of service (QoS).

In more detail, when the apparatus 1002 moves from the SRAT to the TRAT, the RAT processing module 1006 determines that the TRAT is a serving data system. The EPC context processing module 1008 then attempts to transfer the EPC context to the TRAT. However, the failure determination and processing module 1010 may determine that a failure occurs when attempting to transfer the EPC context to the TRAT and categorize the failure as either a temporary failure or a permanent failure. Thereafter, the failure determination and processing module 1010 may attempt to maintain the at least one IP service continuity based on the failure categorization.

When the failure determination and processing module 1010 categorizes the failure as the permanent failure, the RAT processing module 1006 further determines whether the TRAT continues to be the serving data system. When the RAT processing module 1006 determines that the TRAT does not continue to be the serving data system, the EPC context processing module 1008 releases the EPC context.

When the RAT processing module 1006 determines that the TRAT continues to be the serving data system, the PDN processing module 1012 determines whether a failure occurred at the PDN level. When the PDN processing module 1012 determines that the failure did not occur at the PDN level, the EPC context processing module 1008 releases the EPC context.

When the PDN processing module 1006 determines that the failure occurred at the PDN level, the PDN processing module 1006 retries to connect to the PDN by performing an initial attachment procedure via the transmission module 1014. The PDN processing module 1012 then determines whether the apparatus 1002 has successfully connected to the PDN. If the apparatus 1002 is unable to successfully connect to the PDN, the EPC context processing module 1008 releases the EPC context.

When the apparatus 1002 successfully connects to the PDN, the receiving module 1004 may receive a set of parameters from the PDN. The PDN processing module 1004 may then return the set of received parameters to an application running on the apparatus 1002. The set of parameters may include at least one of an IP address, a domain name system (DNS) address, a proxy call session control function (P-CSCF) address, or a quality of service (QoS).

When the failure determination and processing module 1010 categorizes the failure as the temporary failure, the RAT processing module 1006 starts an SRAT timer and determines whether the apparatus 1002 has returned to the SRAT before the SRAT timer expires. When the apparatus 1002 returns to the SRAT before the SRAT timer expires, the EPC context processing module 1008 attempts to transfer the EPC context to the SRAT by performing a handover attachment procedure, and then stops the SRAT timer. Thereafter, the failure determination and processing module 1010 determines whether the EPC context processing module 1008 has successfully transferred the EPC context to the SRAT. If the EPC context processing module 1008 is able to transfer the EPC context to the SRAT, then the apparatus 1002 maintains IP service continuity in the SRAT. However, if the failure determination and processing module 1010 determines that the transfer of the EPC context is not successful, then the PDN processing module 1012 proceeds to determine whether a failure occurred at the PDN level. Thereafter, the PDN processing module 1012, the EPC context processing module 1008, or the receiving module 1004 performs any one of the operations described supra after the determination of whether the failure occurred at the PDN level.

When the apparatus 1002 has not returned to the SRAT, the RAT processing module 1006 determines if the SRAT timer has expired. After the SRAT timer has expired, the RAT processing module 1006 determines whether the TRAT continues to be the serving data system.

After the RAT processing module 1006 determines that the TRAT continues to be the serving data system, the EPC context processing module 1008 attempts to transfer the EPC context to the TRAT by performing a handover attachment procedure. The failure determination and processing module 1010 determines whether the EPC context processing module 1008 has successfully transferred the common core network data context to the TRAT. If the EPC context processing module 1008 is able to transfer the EPC context to the TRAT, then the apparatus 1002 maintains IP service continuity in the TRAT. However, if the failure determination and processing module 1010 determines that the transfer of the EPC context is not successful, then the PDN processing module 1012 proceeds to determine whether a failure occurred at the PDN level. Thereafter, the PDN processing module 1012, the EPC context processing module 1008, or the receiving module 1004 performs any one of the operations described supra after the determination of whether the failure occurred at the PDN level.

When the RAT processing module 1006 determines that the TRAT does not continue to be the serving data system at the time when the SRAT timer expires, the RAT processing module 1006 determines whether a connection with the SRAT or TRAT has been re-acquired and the SRAT or TRAT has been determined to be the serving data system. When the connection with the SRAT or TRAT has been re-acquired and the SRAT or TRAT has been determined to be the serving data system, the EPC context processing module 1008 attempts to transfer the common core network data context to the SRAT or TRAT by performing a handover attachment procedure. The failure determination and processing module 1010 determines whether the EPC context processing module 1008 has successfully transferred the common core network data context to the SRAT or TRAT. If the EPC context processing module 1008 is able to transfer the common core network data context to the SRAT or TRAT, then the apparatus 1002 maintains IP service continuity in the SRAT or TRAT. However, if the failure determination and processing module 1010 determines that the transfer of the common core network data context is not successful, then the EPC context processing module 1008 releases the common core network data context.

The apparatus may include additional modules that perform each of the steps of the algorithm in the aforementioned flow charts of FIGS. 9A-9B. As such, each step in the aforementioned flow charts of FIGS. 9A-9B may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

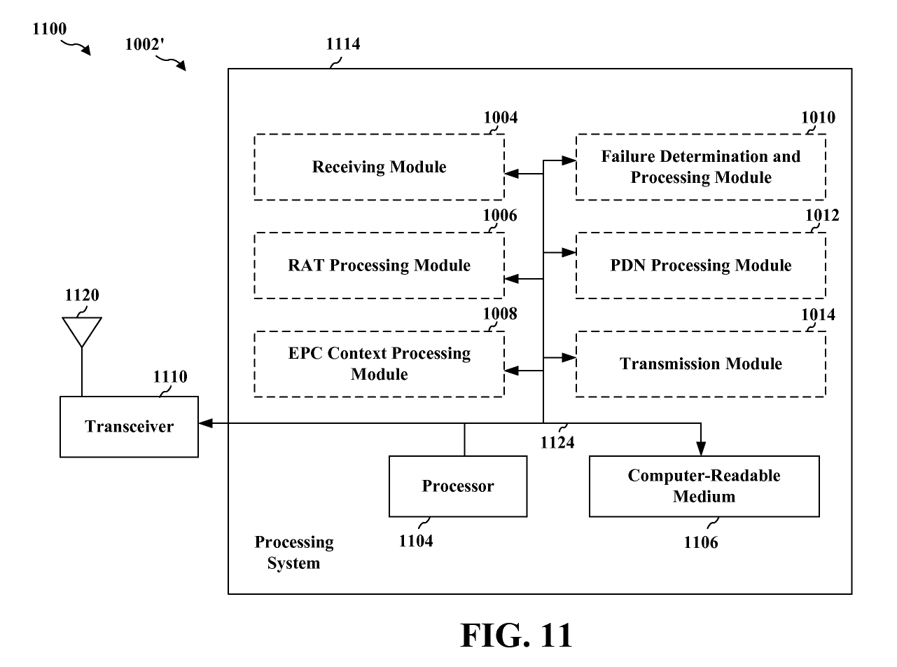

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, 1010, 1012, 1014, and the computer-readable medium 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The processing system 1114 includes a processor 1104 coupled to a computer-readable medium 1106. The processor 1104 is responsible for general processing, including the execution of software stored on the computer-readable medium 1106. The software, when executed by the processor 1104, causes the processing system 1114 to perform the various functions described supra for any particular apparatus. The computer-readable medium 1106 may also be used for storing data that is manipulated by the processor 1104 when executing software. The processing system further includes at least one of the modules 1004, 1006, 1008, 1010, 1012, and 1014. The modules may be software modules running in the processor 1104, resident/stored in the computer readable medium 1106, one or more hardware modules coupled to the processor 1104, or some combination thereof. The processing system 1114 may be a component of the UE 650 and may include the memory 660 and/or at least one of the TX processor 668, the RX processor 656, and the controller/processor 659.

In one configuration, the apparatus 1002/1002′ for maintaining Internet protocol (IP) service continuity during inter-radio access technology (IRAT) handover from a source radio access technology (SRAT) to a target radio access technology (TRAT) within a common core network region includes means for attempting to transfer a common core network data context to a TRAT, means for determining that a failure occurs when attempting to transfer the common core network data context to the TRAT, means for attempting to maintain at least one IP service continuity within the common core network data context according to the failure, means for determining that the TRAT is a serving data system, means for categorizing the failure as a temporary failure or a permanent failure, means for releasing the common core network data context when the TRAT does not continue to be the serving data system, means for determining whether a failure occurred at a packet data network (PDN) level when the TRAT continues to be the serving data system, means for releasing the common core network data context when a failure did not occur at the PDN level, means for retrying to connect to the PDN by performing an initial attachment procedure when a failure occurred at the PDN level, means for releasing the common core network data context when the initial attachment procedure fails to the connect to the PDN, means for receiving a set of parameters from the PDN and returning the set of parameters to an application when the initial attachment procedure successfully connects to the PDN, wherein the set of parameters includes at least one of an IP address, a domain name system (DNS) address, a proxy call session control function (P-CSCF) address, or a quality of service (QoS), means for starting an SRAT timer, means for determining whether the UE has returned to the SRAT before the SRAT timer expires, means for attempting to transfer the common core network data context to the SRAT by performing a handover attachment procedure when the UE has returned to the SRAT, means for determining whether the transfer of the common core network data context is successful, means for determining whether the TRAT continues to be the serving data system when the SRAT timer expires, and means for attempting to transfer the common core network data context to the TRAT by performing a handover attachment procedure when the TRAT continues to be the serving data system.

The aforementioned means may be one or more of the aforementioned modules of the apparatus 1002 and/or the processing system 1114 of the apparatus 1002′ configured to perform the functions recited by the aforementioned means. As described supra, the processing system 1114 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of a user equipment (UE) for maintaining Internet protocol (IP) service continuity during inter-radio access technology (IRAT) handover from a source radio access technology (SRAT) to a target radio access technology (TRAT) within a common core network region, comprising:
attempting to transfer a common core network data context to a TRAT;
determining that a failure occurs when attempting to transfer the common core network data context to the TRAT; and
attempting to maintain at least one IP service continuity within the common core network data context according to the failure.

2. The method of claim 1, wherein the attempt to maintain the at least one IP service continuity includes attempting to maintain a set of parameters including at least one of an IP address, a domain name system (DNS) address, a proxy call session control function (P-CSCF) address, or a quality of service (QoS).

3. The method of claim 1, wherein the attempt to maintain the at least one IP service continuity includes attempting to maintain an entire common core network data context.

4. The method of claim 1, further comprising:
determining that the TRAT is a serving data system; and
categorizing the failure as a temporary failure or a permanent failure,
wherein the attempt to maintain the at least one IP service continuity is based on the failure categorization.

5. The method of claim 4, wherein the failure is categorized as the permanent failure, the method further comprising:
releasing the common core network data context when the TRAT does not continue to be the serving data system.

6. The method of claim 5, further comprising:
determining whether a failure occurred at a packet data network (PDN) level when the TRAT continues to be the serving data system; and
releasing the common core network data context when a failure did not occur at the PDN level.

7. The method of claim 6, further comprising:
retrying to connect to the PDN by performing an initial attachment procedure when a failure occurred at the PDN level;
releasing the common core network data context when the initial attachment procedure fails to the connect to the PDN; and
receiving a set of parameters from the PDN and returning the set of parameters to an application when the initial attachment procedure successfully connects to the PDN,
wherein the set of parameters includes at least one of an IP address, a domain name system (DNS) address, a proxy call session control function (P-CSCF) address, or a quality of service (QoS).

8. The method of claim 4, wherein the failure is categorized as the temporary failure, the method further comprising:
starting an SRAT timer;
determining whether the UE has returned to the SRAT before the SRAT timer expires;
attempting to transfer the common core network data context to the SRAT by performing a handover attachment procedure when the UE has returned to the SRAT; and
determining whether the transfer of the common core network data context is successful.

9. The method of claim 8, when the transfer of the common core network data context is not successful, the method further comprising:
determining whether a failure occurred at a packet data network (PDN) level; and
releasing the common core network data context when a failure did not occur at the PDN level.

10. The method of claim 9, further comprising:
retrying to connect to the PDN by performing an initial attachment procedure when a failure occurred at the PDN level;
releasing the common core network data context when the initial attachment procedure fails to connect to the PDN; and
receiving a set of parameters from the PDN and returning the set of parameters to an application when the initial attachment procedure successfully connects to the PDN,
wherein the set of parameters includes at least one of an IP address, a domain name system (DNS) address, a proxy call session control function (P-CSCF) address, or a quality of service (QoS).

11. The method of claim 8, further comprising:
determining whether the TRAT continues to be the serving data system when the SRAT timer expires;
attempting to transfer the common core network data context to the TRAT by performing a handover attachment procedure when the TRAT continues to be the serving data system; and
determining whether the transfer of the common core network data context is successful.

12. The method of claim 11, when the transfer of the common core network data context is not successful, the method further comprising:
determining whether a failure occurred at a packet data network (PDN) level; and
releasing the common core network data context when a failure did not occur at the PDN level.

13. The method of claim 12, further comprising:
retrying to connect to the PDN by performing an initial attachment procedure when a failure occurred at the PDN level;
releasing the common core network data context when the initial attachment procedure fails to connect to the PDN; and
receiving a set of parameters from the PDN and returning the set of parameters to an application when the initial attachment procedure successfully connects to the PDN,
wherein the set of parameters includes at least one of an IP address, a domain name system (DNS) address, a proxy call session control function (P-CSCF) address, or a quality of service (QoS).

14. The method of claim 1, wherein the SRAT is a long term evolution (LTE) communication system and the TRAT is an enhanced high rate packet data (eHRPD) communication system.

15. The method of claim 1, wherein the SRAT is an enhanced high rate packet data (eHRPD) communication system and the TRAT is a long term evolution (LTE) communication system.

16. A user equipment (UE) for maintaining Internet protocol (IP) service continuity during inter-radio access technology (IRAT) handover from a source radio access technology (SRAT) to a target radio access technology (TRAT) within a common core network, comprising:
means for attempting to transfer a common core network data context to a TRAT;
means for determining that a failure occurs when attempting to transfer the common core network data context to the TRAT; and
means for attempting to maintain at least one IP service continuity within the common core network data context according to the failure.

17. The UE of claim 16, wherein the means for attempting to maintain the at least one IP service continuity is configured to attempt to maintain a set of parameters including at least one of an IP address, a domain name system (DNS) address, a proxy call session control function (P-CSCF) address, or a quality of service (QoS).

18. The UE of claim 16, wherein the means for attempting to maintain the at least one IP service continuity is configured to attempt to maintain an entire common core network data context.

19. The UE of claim 16, further comprising:
means for determining that the TRAT is a serving data system; and
means for categorizing the failure as a temporary failure or a permanent failure,
wherein the attempt to maintain the at least one IP service continuity is based on the failure categorization.

20. The UE of claim 19, wherein the failure is categorized as the permanent failure, the UE further comprising:
means for releasing the common core network data context when the TRAT does not continue to be the serving data system.

21. The UE of claim 20, further comprising:
means for determining whether a failure occurred at a packet data network (PDN) level when the TRAT continues to be the serving data system; and
means for releasing the common core network data context when a failure did not occur at the PDN level.

22. The UE of claim 21, further comprising:
means for retrying to connect to the PDN by performing an initial attachment procedure when a failure occurred at the PDN level;
means for releasing the common core network data context when the initial attachment procedure fails to the connect to the PDN; and
means for receiving a set of parameters from the PDN and returning the set of parameters to an application when the initial attachment procedure successfully connects to the PDN,
wherein the set of parameters includes at least one of an IP address, a domain name system (DNS) address, a proxy call session control function (P-CSCF) address, or a quality of service (QoS).

23. The UE of claim 19, wherein the failure is categorized as the temporary failure, the UE further comprising:
means for starting an SRAT timer;
means for determining whether the UE has returned to the SRAT before the SRAT timer expires;
means for attempting to transfer the common core network data context to the SRAT by performing a handover attachment procedure when the UE has returned to the SRAT; and
means for determining whether the transfer of the common core network data context is successful.

24. The UE of claim 23, when the transfer of the common core network data context is not successful, the UE further comprising:
means for determining whether a failure occurred at a packet data network (PDN) level; and
means for releasing the common core network data context when a failure did not occur at the PDN level.

25. The UE of claim 24, further comprising:
means for retrying to connect to the PDN by performing an initial attachment procedure when a failure occurred at the PDN level;
means for releasing the common core network data context when the initial attachment procedure fails to connect to the PDN; and
means for receiving a set of parameters from the PDN and returning the set of parameters to an application when the initial attachment procedure successfully connects to the PDN,
wherein the set of parameters includes at least one of an IP address, a domain name system (DNS) address, a proxy call session control function (P-CSCF) address, or a quality of service (QoS).

26. The UE of claim 23, further comprising:
means for determining whether the TRAT continues to be the serving data system when the SRAT timer expires;
means for attempting to transfer the common core network data context to the TRAT by performing a handover attachment procedure when the TRAT continues to be the serving data system; and
means for determining whether the transfer of the common core network data context is successful.

27. The UE of claim 26, when the transfer of the common core network data context is not successful, the UE further comprising:
means for determining whether a failure occurred at a packet data network (PDN) level; and
means for releasing the common core network data context when a failure did not occur at the PDN level.

28. The UE of claim 27, further comprising:
means for retrying to connect to the PDN by performing an initial attachment procedure when a failure occurred at the PDN level;
means for releasing the common core network data context when the initial attachment procedure fails to connect to the PDN; and
means for receiving a set of parameters from the PDN and returning the set of parameters to an application when the initial attachment procedure successfully connects to the PDN,
wherein the set of parameters includes at least one of an IP address, a domain name system (DNS) address, a proxy call session control function (P-CSCF) address, or a quality of service (QoS).

29. The UE of claim 16, wherein the SRAT is a long term evolution (LTE) communication system and the TRAT is an enhanced high rate packet data (eHRPD) communication system.

30. The UE of claim 16, wherein the SRAT is an enhanced high rate packet data (eHRPD) communication system and the TRAT is a long term evolution (LTE) communication system.

31. A user equipment (UE) for maintaining Internet protocol (IP) service continuity during inter-radio access technology (IRAT) handover from a source radio access technology (SRAT) to a target radio access technology (TRAT) within a common core network, comprising:
a processing system configured to:
attempt to transfer a common core network data context to a TRAT;
determine that a failure occurs when attempting to transfer the common core network data context to the TRAT; and
attempt to maintain at least one IP service continuity within the common core network data context according to the failure.

32. The UE of claim 31, wherein the processing system configured to attempt to maintain the at least one IP service continuity is further configured to attempt to maintain a set of parameters including at least one of an IP address, a domain name system (DNS) address, a proxy call session control function (P-CSCF) address, or a quality of service (QoS).

33. The UE of claim 31, wherein the processing system configured to attempt to maintain the at least one IP service continuity is further configured to attempt to maintain an entire common core network data context.

34. The UE of claim 31, the processing system further configured to:
determine that the TRAT is a serving data system; and
categorize the failure as a temporary failure or a permanent failure,
wherein the attempt to maintain the at least one IP service continuity is based on the failure categorization.

35. The UE of claim 34, wherein the failure is categorized as the permanent failure, the processing system further configured to:
release the common core network data context when the TRAT does not continue to be the serving data system.

36. The UE of claim 35, the processing system further configured to:
determine whether a failure occurred at a packet data network (PDN) level when the TRAT continues to be the serving data system; and
release the common core network data context when a failure did not occur at the PDN level.

37. The UE of claim 36, the processing system further configured to:
retry to connect to the PDN by performing an initial attachment procedure when a failure occurred at the PDN level;
release the common core network data context when the initial attachment procedure fails to the connect to the PDN; and
receive a set of parameters from the PDN and return the set of parameters to an application when the initial attachment procedure successfully connects to the PDN,
wherein the set of parameters includes at least one of an IP address, a domain name system (DNS) address, a proxy call session control function (P-CSCF) address, or a quality of service (QoS).

38. The UE of claim 34, wherein the failure is categorized as the temporary failure, the processing system further configured to:
start an SRAT timer;
determine whether the UE has returned to the SRAT before the SRAT timer expires;
attempt to transfer the common core network data context to the SRAT by performing a handover attachment procedure when the UE has returned to the SRAT; and
determine whether the transfer of the common core network data context is successful.

39. The UE of claim 38, when the transfer of the common core network data context is not successful, the processing system further configured to:
determine whether a failure occurred at a packet data network (PDN) level; and
release the common core network data context when a failure did not occur at the PDN level.

40. The UE of claim 39, the processing system further configured to:
retry to connect to the PDN by performing an initial attachment procedure when a failure occurred at the PDN level;
release the common core network data context when the initial attachment procedure fails to connect to the PDN; and
receive a set of parameters from the PDN and return the set of parameters to an application when the initial attachment procedure successfully connects to the PDN,
wherein the set of parameters includes at least one of an IP address, a domain name system (DNS) address, a proxy call session control function (P-CSCF) address, or a quality of service (QoS).

41. The UE of claim 38, the processing system further configured to:
determine whether the TRAT continues to be the serving data system when the SRAT timer expires;
attempt to transfer the common core network data context to the TRAT by performing a handover attachment procedure when the TRAT continues to be the serving data system; and
determine whether the transfer of the common core network data context is successful.

42. The UE of claim 41, when the transfer of the common core network data context is not successful, the processing system further configured to:
determine whether a failure occurred at a packet data network (PDN) level; and
release the common core network data context when a failure did not occur at the PDN level.

43. The UE of claim 42, the processing system further configured to:
retry to connect to the PDN by performing an initial attachment procedure when a failure occurred at the PDN level;
release the common core network data context when the initial attachment procedure fails to connect to the PDN; and
receive a set of parameters from the PDN and return the set of parameters to an application when the initial attachment procedure successfully connects to the PDN,
wherein the set of parameters includes at least one of an IP address, a domain name system (DNS) address, a proxy call session control function (P-CSCF) address, or a quality of service (QoS).

44. The UE of claim 31, wherein the SRAT is a long term evolution (LTE) communication system and the TRAT is an enhanced high rate packet data (eHRPD) communication system.

45. The UE of claim 31, wherein the SRAT is an enhanced high rate packet data (eHRPD) communication system and the TRAT is a long term evolution (LTE) communication system.

46. A computer program product of a user equipment (UE) for maintaining Internet protocol (IP) service continuity during inter-radio access technology (IRAT) handover from a source radio access technology (SRAT) to a target radio access technology (TRAT) within a common core network, comprising:
a computer-readable medium comprising code for:
attempting to transfer a common core network data context to a TRAT;
determining that a failure occurs when attempting to transfer the common core network data context to the TRAT; and
attempting to maintain at least one IP service continuity within the common core network data context according to the failure.
